(19) United States
(12) Patent Application Publication
(10) Pub. No.: US 2026/0219428 A1
(43) Pub. Date: Jul. 30, 2026

(54) IN-VEHICLE LENS, LENS UNIT, CAMERA MODULE, AND METHOD FOR MANUFACTURING LENS

(71) Applicants: NIDEC CORPORATION, Kyoto (JP); NIDEC INSTRUMENTS CORPORATION, Nagano (JP)

(72) Inventors: Jennifer Torres DAMASCO TY, Kyoto (JP); Takeru SUGIMOTO, Kyoto (JP); Sayuri NAKAGAWA, Kyoto (JP); Takanori KAMOTO, Kyoto (JP); Masayuki NISHIKAWA, Kyoto (JP); Masataka KAWAKAMI, Nagano (JP); Akinori YAMAMOTO, Nagano (JP); Norihiko SAWAKI, Nagano (JP)

(21) Appl. No.: 19/565,435

(22) Filed: Mar. 12, 2026

Related U.S. Application Data
(63) Continuation of application No. PCT/JP2024/031545, filed on Sep. 3, 2024.

(30) Foreign Application Priority Data
Sep. 12, 2023 (JP) 2023-147871

(51) Int. Cl. G02B 5/20; C08J 7/04; C08J 7/046; C08J 7/054; G02B 1/11; G02B 1/14; G02B 1/18; G02B 7/02

(52) U.S. Cl. CPC G02B 5/208; C08J 7/0423; C08J 7/046; C08J 7/054; G02B 1/18; G02B 7/021; G02B 1/11; G02B 1/14

(57) ABSTRACT

In an in-vehicle lens comprising a transparent base member mainly composed of a resin, a hard coat layer and an antireflection layer are provided on at least one surface of the base member, the antireflection layer is provided on a side opposite to the base member with respect to the hard coat layer, a region from a lens effective diameter to an edge portion in the base member is defined as an extra-effective-diameter region, and in the extra-effective-diameter region, the antireflection layer is covered by a functional film that absorbs ultraviolet rays. Also provided are a lens unit having the in-vehicle lens and a camera module having the lens unit.

### CROSS-REFERENCE TO RELATED APPLICATIONS

This application is a continuation of International Application No. PCT/JP2024/031545, filed on Sep. 3, 2024, which claims priority to Japanese Patent Application No. 2023-147871, filed on Sep. 12, 2023, the entire contents of which are incorporated herein by reference.

### TECHNICAL FIELD

The present invention relates to an in-vehicle lens having a lens mainly composed of a resin. More specifically, the present invention relates to an in-vehicle lens having a hard coat layer, an antireflection layer, and an absorption film for absorbing ultraviolet rays on a surface of a lens mainly composed of a resin. The present invention also relates to a lens unit having the in-vehicle lens and a camera module having the lens unit. Furthermore, the present invention relates to a method for manufacturing a lens.

### BACKGROUND ART

In recent years, in-vehicle cameras mounted on automobiles have been expanding in application as cameras for assisting parking and for image recognition for preventing rear-end collisions or crashes. Particularly, due to increasing social demand for autonomous driving of automobiles, the required performance for in-vehicle lenses has been increasing, and demand for image recognition cameras is expected to continue to grow in the future.

In-vehicle cameras are also used in drive recorders, and the demand for drive recorders is expected to expand over the future. Therefore, the demand for in-vehicle lenses used in drive recorders is also expected to grow hereafter.

On the other hand, plastic lenses, which are lenses mainly composed of a resin, are superior in moldability, lightweight, and capable of keeping costs down compared to conventional lenses mainly composed of glass; therefore, various application developments are being studied. Particularly, the development of plastic lenses for the in-vehicle cameras, for which demand is expected to grow, is an important issue.

However, plastic lenses are susceptible to scratching because they have insufficient hardness compared to lenses mainly composed of glass. Therefore, in a lens unit combining a plurality of lenses, it has been necessary to improve the surface hardness of a plastic lens used on an object side. For example, regarding an optical lens for eyeglasses, there is a proposal in which a hard coat layer is formed adjacent to a lens substrate made of plastic (for example, Patent Literature 1).

### CITATION LIST

### Patent Literature

Patent Literature 1: Japanese Patent Application Laid-Open No. 2016-173613

### SUMMARY OF THE INVENTION

### Problems to be Solved by the Invention

Since the optical lens described in Patent Literature 1 is provided with a hard coat layer on the surface of the lens substrate, it is expected to improve the surface hardness of plastic lenses, which were conventionally considered to have insufficient hardness, and to improve durability quality. That is, application to an in-vehicle lens unit using the optical lens described in Patent Literature 1 as the outermost lens is conceivable. However, when an optical lens having a configuration as in Patent Literature 1 is created, in which a hard coat layer is provided on the surface of a lens substrate made of plastic and an antireflection layer is further formed on the hard coat layer, the periphery of the edge of the optical lens may not be covered by the antireflection layer due to the relationship with the manufacturing process. In a case where the thickness of the hard coat layer is increased to enhance surface hardness, if the optical lens is irradiated with sunlight including ultraviolet rays over a long period of time, the hard coat layer at the periphery of the edge of the optical lens that is not covered by the antireflection layer may be deteriorated by the ultraviolet rays, and the antireflection layer on the deteriorated hard coat layer may also deteriorate.

The present inventors have conducted intensive studies to develop a plastic lens in which deterioration in the function of an antireflection layer is suppressed even during long-term use. That is, an object of the present invention is to provide an in-vehicle lens in which deterioration of an antireflection function is suppressed even during long-term use.

### Means for Solving the Problem

The present invention provides an in-vehicle lens having a transparent base member mainly composed of a resin, wherein a hard coat layer and an antireflection layer are provided on at least one surface of the base member, the antireflection layer is provided on a side opposite to the base member with respect to the hard coat layer, a region from a lens effective diameter to an edge portion in the base member is defined as an extra-effective-diameter region, and the antireflection layer is covered by a functional film having a function of absorbing ultraviolet rays in the extra-effective-diameter region.

### Effect of the Invention

According to the present invention, an in-vehicle lens is provided in which deterioration of an antireflection function is suppressed even during long-term use. Furthermore, according to the present invention, a lens unit having the in-vehicle lens and a camera module having the lens unit are provided.

### BRIEF DESCRIPTION OF THE DRAWINGS

FIG. 1 is a schematic view of an in-vehicle lens of the present invention drawn from above the paper surface along an optical axis.

FIG. 2 is a schematic view drawing the left half of a cross-sectional view taken along line A-A′ passing through the optical axis in FIG. 1.

FIG. 3 is a schematic view drawing a first range and a second range in FIG. 2.

FIG. 4 is a schematic view drawing one embodiment having a water-repellent layer.

FIG. 5 is a schematic view drawing another embodiment having a water-repellent layer.

FIG. 6 is a schematic view drawing one embodiment having a protective film.

FIG. 7 is a schematic view of a lens unit having the in-vehicle lens of the present invention.

FIG. 8 is a diagram showing a relationship between transmittance of a functional film used in Examples and light wavelength.

### MODE FOR CARRYING OUT THE INVENTION

An in-vehicle lens of the present invention (hereinafter also referred to as “the present in-vehicle lens”) is an in-vehicle lens having a transparent base member mainly composed of a resin, wherein a hard coat layer and an antireflection layer are provided on at least one surface of the base member, the antireflection layer is provided on a side opposite to the base member with respect to the hard coat layer, a region from a lens effective diameter to an edge portion in the base member is defined as an extra-effective-diameter region, and in the extra-effective-diameter region, the antireflection layer is covered by a functional film that absorbs ultraviolet rays. It has been found that with the above configuration, deterioration of the antireflection function of the lens is suppressed even during long-term use. The following reasons are considered for this.

A transparent base member mainly composed of a resin has a large expansion coefficient, and when used in an environment with large temperature changes such as inside a vehicle, the volume change becomes large. Therefore, if an antireflection layer is formed directly on a lens mainly composed of a resin, the antireflection layer cannot follow the volume change of the lens mainly composed of a resin, and partial peeling of the antireflection layer from the lens mainly composed of a resin or generation of bubbles between the antireflection layer and the lens mainly composed of a resin may occur. As a result, when used for a long period of time as an in-vehicle lens, the antireflection function of the antireflection layer deteriorates.

On the other hand, by providing a hard coat layer between the lens mainly composed of a resin and the antireflection layer, it is considered that the hard coat layer also plays a buffering function, exhibiting an effect of compensating for a difference in volume expansion between the lens mainly composed of a resin and the antireflection layer. As a result, it is considered that deterioration of the antireflection function is suppressed.

However, at the periphery of the edge of the lens, the hard coat layer may not be covered by the antireflection layer. This is because the antireflection layer is often formed on the hard coat layer by a dry process such as a sputtering method, and as described later, the lens is held in a state where the periphery of the edge of the lens is covered, so the hard coat layer at the periphery of the edge of the lens may not be covered with the antireflection layer. The antireflection layer has a function of reflecting ultraviolet rays as described later. Therefore, if the hard coat layer is thickened to achieve higher hardness of the hard coat layer (for example, a pencil hardness of 5H or more) in a state where the hard coat layer at the periphery of the edge of the lens is not reflected by the antireflection layer, the hard coat layer at the periphery of the edge of the lens may deteriorate due to ultraviolet rays. When the hard coat layer deteriorates, the above-mentioned buffering function decreases, so the antireflection layer may partially peel off from the hard coat layer. That is, it is considered that the antireflection function of the in-vehicle lens decreases with long-term use. In the present in-vehicle lens, by providing a functional film that absorbs ultraviolet rays at the periphery of the edge of the lens, the hard coat layer not covered by the antireflection layer is protected from ultraviolet rays; therefore, the buffering function by the hard coat layer is maintained for a longer period of time, and as a result, it is considered that deterioration of the antireflection function during long-term use is further suppressed.

The transparent base member mainly composed of a resin used for the present in-vehicle lens is mainly composed of a resin that is transparent to visible light and has a high refractive index. The resin to be used is usually preferably an amorphous resin having a high glass transition temperature from the viewpoint of hardness. The glass transition temperature of the resin is usually measured in accordance with JIS-K7121, and a resin having a glass transition temperature of 110° C. or higher is preferable, and 130° C. or higher is more preferable. In addition, from the viewpoint of moldability and the like of the base member, the glass transition temperature of the resin that is the main component of the base member is preferably 200° C. or lower. From the viewpoint of a balance between hardness and moldability, the glass transition temperature of the resin that is the main component of the base member is preferably 110° C. or higher and 200° C. or lower, and from the viewpoint of thermal stability, 130° C. or higher and 200° C. or lower is more preferable.

Examples of the resin include acrylic resins, polycarbonates, polystyrenes, polyvinyl chlorides, urethane resins, thiourethane resins, episulfide-based resins, and diallyl phthalate-based resins. Examples of the acrylic resins include polymethyl methacrylate, polymethacrylate, polybutyl methacrylate, epoxy methacrylate, and urethane methacrylate. Examples of the polycarbonates include polydiethylene glycol bisallyl carbonate and allyl diglycol carbonate.

Further, as the resin that is the main component of the base member, a resin having a cyclic imide structure as a ring structure is also preferable. More specifically, it is a methacrylic resin having a structural unit having a ring structure in a main chain, and a resin containing at least one type of structural unit among structural units derived from N-substituted maleimide monomers and glutarimide-based structural units is preferable from the viewpoints of both heat resistance and optical properties. For example, the resin that is the main component of the base member is preferably a resin containing a structural unit (X) having the above ring structure in a main chain and a structural unit (Y) derived from a methacrylic acid ester monomer. The resin that is the main component of the base member is more preferably a resin consisting only of the structural unit (X) and the structural unit (Y).

A lens member mainly composed of the resin having a cyclic imide structure is transparent and has a glass transition temperature Tg higher by 30° C. to 40° C. than that of ordinary methacrylic resins and the like. Therefore, when a lens member mainly composed of the resin having a cyclic imide structure is used, it does not deform even when exposed to a temperature of, for example, 110° C., and the light transmittance exceeds 90%. Such resins are exemplified in, for example, Japanese Patent Application Laid-Open No. 2018-53044 and Japanese Patent Application Laid-Open No. 2020-63436.

The structural unit (Y) derived from a methacrylic acid ester monomer is derived from, for example, one or two or more monomers selected from the methacrylic acid esters shown below. Examples of the methacrylic acid ester include methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclopentyl methacrylate, cyclohexyl methacrylate, cyclooctyl methacrylate, tricyclodecyl methacrylate, dicyclooctyl methacrylate, and tricyclododecyl methacrylate.

The structural unit (X) derived from the N-substituted maleimide monomer is formed from one or more structural units selected from the group consisting of a structural unit represented by the following formula (1) and a structural unit represented by the following formula (2).

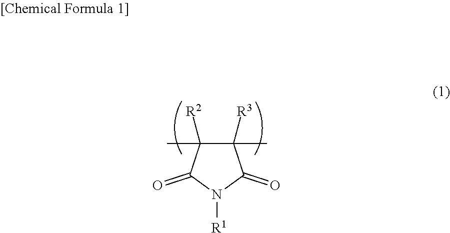

In the formula (1), R¹ is an arylalkyl group having 7 to 14 carbon atoms or an aryl group having 6 to 14 carbon atoms. R² and R³ are each a hydrogen atom, an oxygen atom, a sulfur atom, an alkyl group having 1 to 12 carbon atoms, or an aryl group having 6 to 14 carbon atoms. When R² or R³ is an aryl group, R² or R³ may contain a halogen atom as a substituent.

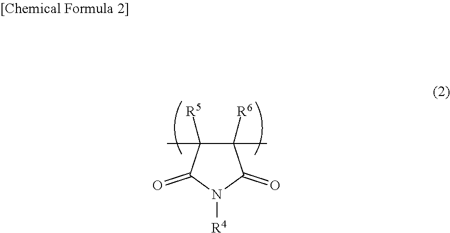

In the formula (2), R⁴ is a hydrogen atom, a cycloalkyl group having 3 to 12 carbon atoms, or an alkyl group having 1 to 12 carbon atoms. R⁵ and R⁶ are each a hydrogen atom, an oxygen atom, a sulfur atom, an alkyl group having 1 to 12 carbon atoms, or an aryl group having 6 to 14 carbon atoms.

The glutarimide-based structural unit (X) is represented by the following formula (3).

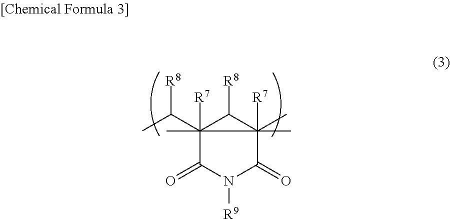

In the formula (3), R⁷ and R⁸ are each, for example, a hydrogen atom or a methyl group. A plurality of R⁷ and R⁸ may be the same or different. R⁹ is a hydrogen atom, a methyl group, a butyl group, or a cyclohexyl group. Among these, a combination in which R⁷ is a methyl group, R⁸ is hydrogen, and R⁹ is a methyl group is preferable.

The resin is the main component of the base member. Here, the main component means that the content of the resin in the base member is more than 50% by mass when the total mass of the base member is 100% by mass. When the total mass of the base member is 100% by mass, the content of the resin in the base member is preferably 55% by mass or more, more preferably 70% by mass or more, still more preferably 90% by mass or more, and particularly preferably 100% by mass.

The base member may be a hybrid glass. The hybrid glass is, for example, a synthetic “glass” made from the resin and a silanol compound. Further, an additive such as a stabilizer that is usually used may be added to the resin. The addition amount of the stabilizer is preferably 2 parts by mass or more from the viewpoint of effect, and 1 part by mass or less from the viewpoint of transparency of the lens, based on 100 parts by mass of the resin used for the base member.

The transparent base member mainly composed of a resin (hereinafter also referred to as “the present base member”) is used after being molded into a shape having a lens function for use as an in-vehicle lens. Examples of the shape having a lens function include a shape in which both side surfaces are a spherical surface and a spherical surface, or a spherical surface and a flat surface, such as a biconvex lens shape in which both surfaces are convex, a plano-convex lens shape in which one surface is convex and the other surface is a flat surface, and a convex meniscus shape in which one surface is convex and the other surface is concave. As will be described later, when the present in-vehicle lens is used on the object side of a lens unit, it is preferable to use the convex side on the object side from the viewpoint of resolution, and the shape used is preferably a plano-convex lens shape or a convex meniscus shape from the viewpoint of downsizing the lens unit and a camera module described later.

In the present in-vehicle camera, a hard coat layer and an antireflection layer are provided on at least one surface of the present base member, the antireflection layer is provided on a side opposite to the base member with respect to the hard coat layer, and the antireflection layer is covered with a functional film that absorbs ultraviolet rays at the periphery of the edge of the present base member (corresponding to an “extra-effective-diameter region” described later). The hard coat layer and the antireflection layer may be provided on either surface of the present base member, and it is preferable that at least one surface of the present base member on which the hard coat layer and the antireflection layer are provided on both surfaces is a surface facing the object side when the present in-vehicle lens is used on the object side of the lens unit, from the viewpoint of further suppressing the deterioration of the antireflection function during long-term use.

A hard coat layer provided on at least one surface of the present base member (hereinafter also referred to as “the present hard coat layer”) has effects of imparting scratch resistance to the lens unit and enhancing adhesion between the present base member and an antireflection layer described later, when the present in-vehicle lens is used on the object side of the lens unit. The present hard coat layer preferably has a pencil hardness of 5H or more in the case of a lens used inside a vehicle, and more preferably has a pencil hardness of 6H or more in the case of a lens used outside a vehicle, for example, from the viewpoint of scratch resistance due to car washing and the like.

The present hard coat layer preferably includes a base layer composed of an organic material layer or an organosilicon compound layer. Further, the present hard coat layer is preferably composed of a layer in which metal oxide fine particles are dispersed in the base layer. Examples of the metal oxide fine particles include metal oxides such as SiO₂, Al₂O₃, SnO₂, and TiO₂, and SiO₂ is preferable from the viewpoint of hardness.

Various resin layers are used for the organic material layer. For the organosilicon compound layer, for example, tetramethoxysilane, tetraethoxysilane, tetrapropoxysilane, tetraisopropoxysilane, tetrabutoxysilane, vinyltrialkoxysilane, allyltrialkoxysilane, acryloxypropyltrialkoxysilane, or the like is used.

The present hard coat layer is usually formed by a method of applying a coating liquid containing the organic material or organosilicon compound to become the base layer and, if necessary, metal oxide fine particles onto the surface of the present base member and drying it. Examples of the application method include wet processes such as a dip coating method, a spray coating method, a roll coating method, a doctor blade method, a spin coating method, a gravure coating method, and a screen printing method. When forming the present hard coat layer, a pretreatment such as an acid treatment or a primer treatment for improving adhesion between the present base member and the present hard coat layer may be performed on the surface of the present base member.

The film of the coating liquid formed on the surface of the present base member by the above method is cured by heat, electromagnetic waves such as ultraviolet rays, or an electron beam. In the case of using heat, a method of heating and drying at a temperature of 40° C. or higher and 200° C. or lower for about several hours after applying the coating liquid can be exemplified. In the hard coat layer after curing, the content of the metal oxide fine particles is preferably 25% to 50%. If the content of the metal oxide fine particles in the cured hard coat layer is less than 25%, the hardness of the formed present hard coat layer may be insufficient. On the other hand, if the content of the metal oxide fine particles in the cured hard coat layer exceeds 50%, cracks may occur in the present hard coat layer.

The present hard coat layer preferably uses a photocurable resin material as the organic material layer. For example, in a hard coat layer forming step, a coating liquid containing a photocurable resin material composed of acrylic and/or urethane and metal oxide fine particles is applied onto the surface of the present base member by a spin coating method to form a film of the coating liquid. When the coating liquid contains water or an organic solvent described later, these water or organic solvent are dried to form a film of the coating liquid. After the film of the coating liquid is dried by applying heat, it is photocured by electromagnetic waves such as ultraviolet rays or an electron beam to form the present hard coat layer. By forming the present hard coat layer by photocuring in this way, there is no need to apply heat, and the present hard coat layer can be formed at a temperature lower than the glass transition temperature Tg of the present base member. Furthermore, since the present hard coat layer is a photocurable resin composed of acrylic and/or urethane or the like, it has excellent adhesion to the present base member and functions as an excellent buffer layer between the present base member and an antireflection layer described later. In the above example, a photocurable resin material was used as the material of the present hard coat layer, but the material of the present hard coat layer may be a thermosetting resin material instead of the photocurable resin material. In this case, it is preferable to use a thermosetting resin material that thermosets at a temperature lower than the glass transition temperature Tg of the present base member. As the material of the hard coat layer, commercially available Nidek Acier J50PG (Nidek Acier is a registered trademark) is suitably used.

The application method is preferably a spin coating method. In the spin coating method, after the coating liquid is dropped onto the surface of the present base member on which the present hard coat layer is to be formed, the present base member is rotated around the optical axis to form a film of the coating liquid. At that time, in order to form the present hard coat layer sufficiently thick, it is conceivable to increase the viscosity of the coating liquid, but if the viscosity of the coating liquid is increased while keeping the conventional application conditions, the uniformity of the film of the coating liquid deteriorates, and the shape of the present in-vehicle lens is substantially distorted. Therefore, a coating liquid having a relatively high viscosity of 26 mPa's or more and 50 mPa's or less is applied, and after dropping the coating liquid so that the coating liquid spreads over the entire surface of the present base member, the rotation of the spin coater is controlled and application is performed so that the film of the coating liquid becomes uniform.

More specifically, first, in the primary rotation, a method is exemplified in which the rotation speed of the spin coater is gradually accelerated with a predetermined acceleration gradient, rotated at a constant speed for a certain period of time, and then gradually decelerated with a predetermined deceleration gradient.

For example, in the primary rotation, the acceleration gradient is set in the range of 100 rpm/s to 3000 rpm/s, the angular velocity during constant speed rotation is set in the range of 900 rpm to 3000 rpm, and the deceleration gradient is set in the range of 100 rpm/s to 3000 rpm/s. For example, in the primary rotation, the angular velocity when rotating at a constant speed for a certain period of time is 1000 rpm, and the rotation time is 10 seconds. In addition, the acceleration gradient until the angular velocity reaches 1000 rpm is 333 rpm/s, and the deceleration gradient is 200 rpm/s.

Next, the application state after the primary rotation is confirmed, and depending on the confirmation result, a secondary rotation is performed in which rotation is performed at a speed faster than the primary rotation for a certain period of time. In the secondary rotation, similarly to the primary rotation, the rotation speed of the spin coater is gradually accelerated with a predetermined acceleration gradient, rotated at a constant speed for a certain period of time, and then gradually decelerated with a predetermined deceleration gradient. More specifically, the angular velocity during constant speed rotation is set to twice or more the angular velocity in the primary rotation.

For example, in the secondary rotation, the angular velocity when rotating at a constant speed for a certain period of time is 3000 rpm, and the rotation time is 9 seconds. In addition, the acceleration gradient until the angular velocity reaches 3000 rpm is 3000 rpm/s, and the deceleration gradient is 600 rpm/s.

When forming the coating film of the coating liquid by performing the primary rotation and the secondary rotation, the secondary rotation may be configured such that the rotation is gradually accelerated with a predetermined acceleration gradient without decelerating from the constant speed rotation of the primary rotation, rotated at a constant speed for a certain period of time, and then gradually decelerated with a predetermined deceleration gradient.

By the above method, by using a coating liquid having a relatively high viscosity of 26 mPa's or more and 50 mPa·s or less, it becomes possible to thicken the present hard coat layer. Further, by setting the conditions of the spin process after dropping the coating liquid to the above conditions and making the velocity gradients during acceleration and deceleration gentle, sudden acceleration and sudden stop are prevented. For this reason, since the moment of inertia associated with sudden acceleration and sudden stop can be reduced, variations in the thickness of the coating film are unlikely to occur even when the present hard coat layer of sufficient thickness is formed.

The coating liquid contains water or an organic solvent that dissolves or disperses the organic material or organosilicon compound to become the base layer and, if necessary, metal oxide fine particles. Examples of the organic solvent include acetone, methyl ethyl ketone, pentane, hexane, ethanol, propanol, and isopropanol.

The thickness of the present hard coat layer is preferably 3 μm or more and 20 μm or less. Further, the thickness of the present hard coat layer may change from the optical axis to the outer edge of the present in-vehicle lens. For example, it is conceivable to form the present hard coat layer such that the film thickness of the present hard coat layer formed on the optical axis of the surface of the present base member on which the present hard coat layer is formed is about 8 μm, and the film thickness of the present hard coat layer formed on the outer edge portion of the surface on which the present hard coat layer is formed is within +1 μm with respect to the film thickness of the present hard coat layer formed on the optical axis of said surface. By setting the film thickness of the hard coat layer in such a range, the present in-vehicle lens can be made less likely to cause optical distortion of transmitted light.

The thickness of the present hard coat layer is preferably 5 μm or more from the viewpoint that a pencil hardness of 6H or more can be realized. Further, from the viewpoint that the occurrence of cracks due to thermal shock can be further suppressed, the thickness of the present hard coat layer is preferably 10 μm or less. From the above viewpoint, the thickness of the present hard coat layer is more preferably 6 μm or more and 9 μm or less.

In the present in-vehicle lens, an antireflection layer (hereinafter also referred to as “the present antireflection layer”) is provided on at least one surface of the present base member. The present antireflection layer is provided at least on the surface of the present base member on which the present hard coat layer is provided, and is provided on a side opposite to the base member with respect to the present hard coat layer. The present antireflection layer only needs to be provided on the surface of the present base member on which the present hard coat layer is provided, and the present antireflection layer may be provided on the surface of the present base member on which the present hard coat layer is not formed. By providing the antireflection layer, the possibility that a captured image is affected by ghosting or flare is reduced.

The present antireflection layer is preferably composed of a dielectric multilayer film in which low refractive index films and high refractive index films are alternately laminated. For example, the present antireflection layer includes an antireflection layer composed of a dielectric multilayer film in which silicon dioxide films (SiO₂ films) as low refractive index films and trisilicon tetranitride films (Si₃N₄ films) as high refractive index films are alternately laminated.

In the present antireflection layer, it is desirable that the uppermost layer is a silicon dioxide film. Further, the film thickness of the silicon dioxide film of the uppermost layer is preferably 60 nm or more. Here, the multilayer formed in the present antireflection layer is preferably about 5 layers or 7 layers in consideration of layer performance and efficiency of formation work. Further, the total thickness of the present antireflection layer is preferably 200 nm or more and 500 nm or less, and more preferably 280 nm or more and 500 nm or less, from the viewpoint of the antireflection performance of the obtained present in-vehicle lens.

If the total film thickness of the present antireflection layer exceeds 500 nm, the stress of the present antireflection layer may be too high, the coating becomes easily cracked, and the temperature of the present base member may excessively rise during formation, causing an influence on the lens surface. Further, if the total film thickness of the present antireflection layer is less than 200 nm, appropriate antireflection characteristics may not be obtained, it is difficult to ensure the hardness of the present antireflection layer, and scratches may easily occur. In addition, by optimizing the total film thickness of the present antireflection layer to suppress the temperature rise of the present base member when forming the present antireflection layer, it is possible to suppress a change in Modulation Transfer Function (MTF). Therefore, high-quality images can be obtained, such as being able to maintain high resolution.

The present in-vehicle lens provided with such a present antireflection layer is considered to exhibit an excellent antireflection effect against visible light having a wavelength longer than 420 nm. After forming the present antireflection layer, an antifouling layer composed of a fluorine-containing silane compound may be formed for the purpose of improving the water and oil repellency of the surface of the present base member. As for the fluorine-containing silane compound, a method of applying it onto the antireflection layer using a water-repellent treatment liquid adjusted to a predetermined concentration by dissolving it in an organic solvent can be exemplified.

The present antireflection layer is formed by a dry process such as a physical vapor deposition method (PVD method) including a vacuum deposition method, a sputtering method, and an ion plating method, or a chemical vapor deposition method (CVD method), at least on the surface of the present base member on which the present hard coat layer is formed. The sputtering method is preferable from the viewpoint of high scratch resistance and abrasion resistance. In the present antireflection layer, the average reflectance of ultraviolet rays having a wavelength of 315 nm or more and 365 nm or less is preferably 30.0% or more. For further suppressing deterioration of the hard coat layer, the average reflectance is more preferably 70.0% or more. In other words, in the present antireflection layer, the average transmittance of ultraviolet rays having a wavelength of 315 nm or more and 365 nm or less is preferably 70.0% or less, and from the viewpoint of further suppressing deterioration of the hard coat layer, the average transmittance of ultraviolet rays having a wavelength of 315 nm or more and 365 nm or less is more preferably 30.0% or less. Note that in the following description, ultraviolet rays having a wavelength of 315 nm or more and 365 nm or less may be simply referred to as ultraviolet rays, and the average transmittance and average reflectance for ultraviolet rays of this wavelength may be simply referred to as transmittance and reflectance. In one embodiment of the present invention, when forming the present antireflection layer by a sputtering method, the present base member is placed in a holder and held from a side opposite to the holder with respect to the base member by a cover having a hole slightly smaller than the diameter of the base member. At this time, the diameter of the hole of the cover is usually larger than the lens effective diameter. That is, a part of the periphery of the edge of the base member is in a state of being slightly covered by the cover. Since the antireflection layer is formed on the present base member held in such a state, as described later, a portion in which a part of the hard coat layer is not covered by the antireflection layer occurs in the extra-effective-diameter region of the present in-vehicle lens.

The present in-vehicle lens has, in addition to the present hard coat layer and the present antireflection layer, a functional film that absorbs ultraviolet rays (hereinafter also referred to as “the present functional film”) in an extra-effective-diameter region defined from the lens effective diameter to the edge portion of the base member, and the antireflection layer is covered by the present functional film in the extra-effective-diameter region. With such a configuration, it is considered that deterioration of the present hard coat layer when the present in-vehicle lens is used for a long period of time is suppressed, and deterioration of the antireflection function of the present in-vehicle lens is suppressed.

The present functional film has a function of absorbing ultraviolet rays. The ultraviolet absorption function of the present functional film preferably includes a function of absorbing ultraviolet rays having a wavelength of 315 nm or more and 365 nm or less. Further, the average absorption rate of ultraviolet rays having a wavelength of 315 nm or more and 365 nm or less is preferably 98.0% or more per 1 nm in terms of thickness, and more preferably 98.7% or more. In other words, the average transmittance of ultraviolet rays of the present functional film is preferably 2.0% or less per 1 nm in terms of thickness, and more preferably 1.3% or less. Note that in the following description, the average absorption rate for ultraviolet rays having a wavelength of 315 nm or more and 365 nm or less may be simply referred to as an absorption rate.

Materials used for the present functional film include, for example, an ultraviolet absorber, a light stabilizer, or a resin containing at least one of an ultraviolet absorber and a light stabilizer. Examples of the ultraviolet absorber include triazine compounds, benzotriazole compounds, benzophenone compounds, salicylate compounds, and cyanoacrylate materials. Examples of the light stabilizer include hindered amine compounds. Commercially available ultraviolet absorbers and light stabilizers can be suitably used as these ultraviolet absorbers and light stabilizers.

Examples of the resin containing at least one of an ultraviolet absorber and a light stabilizer include fluorine-based resins, acrylic-based resins, and urethane-based resins. Examples of the fluorine-based resins include polytetrafluoroethylene (tetrafluoroethylene resin), perfluoroalkoxyalkane (tetrafluoroethylene-perfluoroalkyl vinyl ether copolymer resin), perfluoroethylene propene copolymer (tetrafluoroethylene-hexafluoropropylene copolymer resin), ethylene-tetrafluoroethylene copolymer (tetrafluoroethylene-ethylene copolymer resin), polyvinylidene fluoride (vinylidene fluoride resin), polychlorotrifluoroethylene (trifluorochloroethylene resin), ethylene-chlorotrifluoroethylene copolymer (trifluorochloroethylene-ethylene copolymer resin), tetrafluoroethylene-perfluorodioxole copolymer (tetrafluoroethylene-perfluorodioxole copolymer resin), and polyvinyl fluoride.

Examples of the acrylic resin include polymethyl methacrylate, polyacrylic acid ester which is a copolymer of acrylic acid ester and methacrylic acid ester or styrene, polyacrylic acid sodium in which acrylic acid ester or vinyl acetate is copolymerized with sodium acrylate, polyacrylonitrile in which acrylic acid ester, methacrylic acid ester, etc. are copolymerized with acrylonitrile, and polyacrylamide obtained by hydrolyzing acrylonitrile.

As the urethane-based resin, various urethane-based resins can be obtained by a combination of an isocyanate and a polyol. For example, examples of the isocyanate include diphenylmethane diisocyanate, tolylene diisocyanate, hexamethylene diisocyanate, isophorone diisocyanate, xylylene diisocyanate, hydrogenated xylylene diisocyanate, naphthalene diisocyanate, and norbornene diisocyanate. As the polyol, three types of polyether glycol, polyester polyol, and polymer polyol are used. Examples of the polyether polyol include polyether polyol obtained by addition polymerization of ethylene oxide or propylene oxide having an epoxy group using a polyhydric alcohol or an amine as an initiator in the presence of a basic catalyst, or polyoxypropylene triol obtained by addition polymerization of propylene oxide to glycerin. Examples of the polyester polyol include those obtained by dehydration condensation of a carboxylic acid and a polyhydric alcohol, where examples of the carboxylic acid include adipic acid and phthalic acid, and examples of the polyhydric alcohol include ethylene glycol, 1,4-butanediol, and 1,6-hexanediol. Examples of the polymer polyol include acrylic polyol of an acrylic resin obtained by copolymerizing an acrylic acid ester and a vinyl compound, epoxy polyol obtained by amine-modifying or amino alcohol-modifying a bisphenol-type epoxy resin, polyolefin-based polyol having a hydroxyl group at a terminal of a polymer of butadiene or a copolymer of butadiene and acrylonitrile or styrene, and fluorine-containing polyol composed of alternating copolymerization of chlorofluoroethylene and vinyl ethers.

The present functional film can be formed, for example, by applying a coating liquid obtained by dissolving or dispersing the resin containing at least one of the ultraviolet absorber, the light stabilizer, or the ultraviolet absorber and the light stabilizer in water or an organic solvent onto the present antireflection layer and drying it. The present functional film is formed in the extra-effective-diameter region of the present base member in consideration of the influence on the optical performance of the present in-vehicle lens. However, if the functional film does not affect the optical performance of the lens, the present functional film may be formed on the entire surface of the present in-vehicle lens, that is, on the antireflection layer in the effective diameter region and on the hard coat layer not covered by the antireflection layer. That is, if the optical performance of the lens is not affected, the present functional film only needs to cover at least a part of the present antireflection layer in the extra-effective-diameter region, and may be applied to a desired portion of the present antireflection layer where the present functional film is to be formed.

As an application method, a method using a spin coating method is conceivable. As an example, a method of applying the coating liquid with a brush while rotating the present base member with a spin coater can be mentioned. The organic solvent contained in the coating liquid may be the same as those exemplified for the formation of the present hard coat layer. The thickness of the present functional film is preferably 4,000 nm or more and 20,000 nm or less.

The present protective film is formed by applying and drying the coating liquid containing the resin containing at least one of the ultraviolet absorber, the light stabilizer, or the ultraviolet absorber and the light stabilizer to a desired portion of the present antireflection layer where the present functional film is to be formed.

As described above, the present in-vehicle lens is obtained, in which the present hard coat layer and the present antireflection layer are provided on at least one surface of the present base member, the present antireflection layer is provided on the side opposite to the base member with respect to the present hard coat layer, and at least a part of the present antireflection layer is covered by the present functional film.

In the above aspect, the present in-vehicle lens may have a layer or film other than the present hard coat layer, the present antireflection layer, and the present functional film. For example, the present in-vehicle lens may have a water-repellent layer or a protective film described later. Further, a primer layer or an anchor layer may be provided between the present hard coat layer and the present antireflection layer, or between the present antireflection layer and the present functional film for the purpose of improving adhesion therebetween. The primer layer and the anchor layer can be formed by the same method as exemplified for the formation of the present hard coat layer.

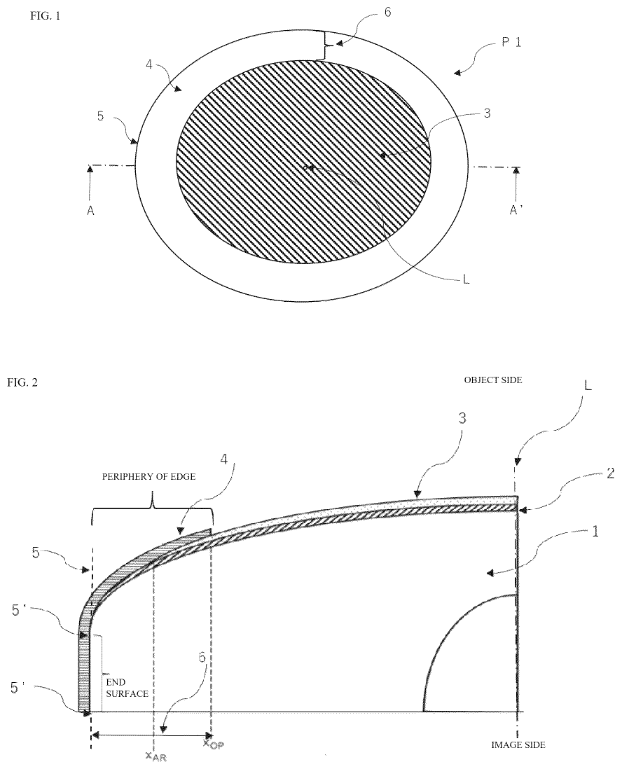

Examples of aspects of the present in-vehicle lens will be described with reference to FIGS. 1 and 2. FIG. 1 is a schematic view of the present in-vehicle lens P1 drawn from above the paper surface. The optical axis of the present in-vehicle lens P1 is in a direction perpendicular to the paper surface. FIG. 2 is a schematic view drawing the left half of the A-A′ cross-sectional view passing through the optical axis in FIG. 1. Usually, since the present in-vehicle lens P1 is symmetrical with respect to a plane passing through the optical axis, only the left half will be described in the following schematic views, but the right half is the same as the left half. In FIG. 2, the present base member 1 has a plano-convex lens shape with one surface being convex and the other surface being a flat surface, and the convex side is the object side when a lens unit described later is used. The end surface of the present base member 1 is between both ends, where one end is a position where the curvature of the spherical surface on the object side of the present base member changes, and another end is a position on the image side surface of the present base member. Although the end surface of the present base member is flat and parallel to the optical axis, the present in-vehicle lens is not limited to these shapes. For example, when the present base member has a biconvex lens shape, the both ends coincide, and thus the end surface is the same as the ends.

In FIG. 2, the present hard coat layer 2 is formed directly on the present base member 1 and is formed from the optical axis L to a position before the end. On the other hand, the present antireflection layer 3 is formed directly on the present hard coat layer 2 and on the side opposite to the base member 1 with respect to the present hard coat layer 2.

The present functional film 4 is continuously formed on the present antireflection layer 3 along the periphery of the edge portion, which is the extra-effective-diameter region of the present base member 1 (not shown), as shown in FIG. 1. In FIG. 2, there is a portion where the present functional film 4 is formed directly on the present hard coat layer 2, and such a configuration is preferable from the viewpoint that cracks of the present hard coat layer when the present in-vehicle lens is used for a long period of time are suppressed, and deterioration of the antireflection function of the present in-vehicle lens is suppressed. The present functional film 4 preferably covers the edge portion including the end surface of the present base member 1 as shown in FIG. 2.

Further, the region from the lens effective diameter to the end surface in the present base member is defined as the extra-effective-diameter region as the periphery of the edge, and the functional film covers the present antireflection layer in the extra-effective-diameter region. The extra-effective-diameter region, which is the periphery of the edge of the present base member, is a range from the outermost position X_{OP} of the effective diameter of the present in-vehicle lens to the end surface in a direction opposite to the optical axis, as shown in FIG. 2. Note that the effective diameter of a lens is a diameter of a region in which the base member guarantees optical functions of the lens, and the outermost position of the effective diameter is a position farthest from the optical axis in the region in which the base member guarantees optical functions of the lens. From the viewpoint of suppressing the deterioration of the antireflection function of the present in-vehicle lens, as shown in FIG. 2, an aspect in which the present functional film 4 covers the present antireflection layer 3 in the extra-effective-diameter region 6 is preferable, and covering to the end surface is more preferable. For example, when there is a possibility that the hard coat layer is exposed at the end surface, the hard coat layer at the end surface can also be protected by covering the end surface with the functional film.

That the present functional film 4 covers the present antireflection layer 3 in the extra-effective-diameter region 6 refers to a state in which the outermost position X_{AR} of the present antireflection layer 3 is in the extra-effective-diameter region, as shown in FIG. 2.

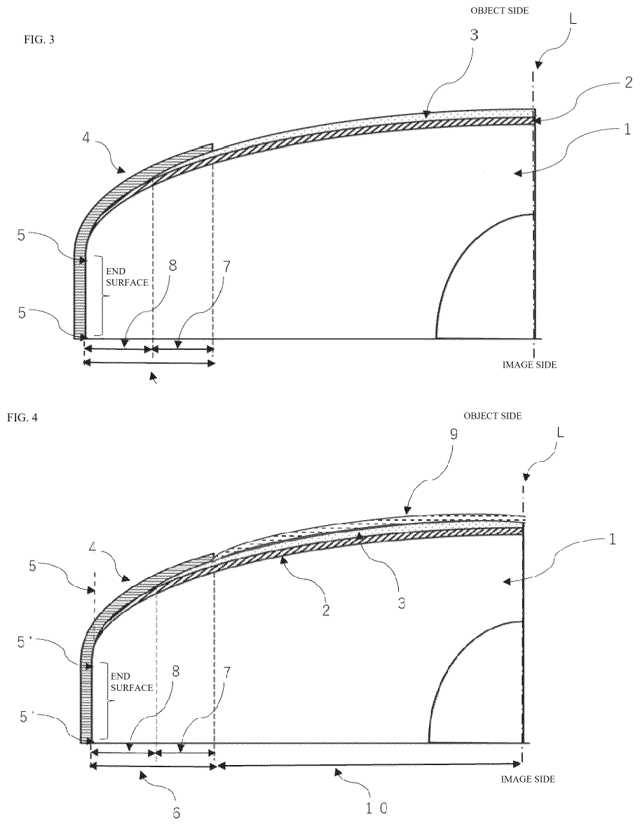

Furthermore, from the viewpoint of suppressing the deterioration of the antireflection function of the present in-vehicle lens, as shown in FIG. 3, when the extra-effective-diameter region is divided into a first region 7 and a second region 8 in this aspect, the present functional film 4 is in contact with the present antireflection layer 3 in the first region 7 and is in contact with the hard coat layer 2 in the second region 8. That is, it is preferable that the end of the present antireflection layer 3 opposite to the optical axis is in the first region 7, and the end of the hard coat layer 2 is in the second region 8. The first region is a range from the outermost position X_{OP} of the effective diameter of the present in-vehicle lens to a direction opposite to the optical axis, in which the functional film covers the antireflection layer in the extra-effective-diameter region, and the region other than the first region in the extra-effective-diameter region is the second region. Therefore, the present functional film 4 comes into contact with the present antireflection layer 3 in the first region of the extra-effective-diameter region, and comes into contact with the hard coat layer 2 outside the range where the present antireflection layer 3 is covered in the extra-effective-diameter region. As described above, when the antireflection film is formed by the sputtering method, the present base member is sandwiched by the holder and the cover. The state in which a part of the extra-effective-diameter region of the in-vehicle lens is covered by the cover may differ depending on the in-vehicle lens. Therefore, since the end of the antireflection layer also differs depending on the in-vehicle lens, the position of the boundary line between the first region, which is the range where the functional film covers the antireflection layer, and the second region, which is the other region, is considered to differ depending on the in-vehicle lens. Further, the center of the hole of the cover and the center (optical axis) of the sandwiched lens may not necessarily coincide. Therefore, the position of the boundary line between the first region and the second region may change along the circumferential direction of the lens even in the same in-vehicle lens.

The present in-vehicle lens may have a water-repellent layer in addition to the present hard coat layer, the present antireflection layer, and the present functional film. The water-repellent layer is a thin film having water repellency, and for example, a film in which the contact angle of a water droplet with respect to the water-repellent layer is 90 degrees or more is preferable. The measurement of the contact angle is a method of using a static drop method (A half-angle Method), dropping a 2.5 microliter water droplet on the surface of the present base member on which the water-repellent layer is formed, and measuring the contact angle of the water droplet assuming that a curved surface connecting the left and right endpoints of the droplet is a straight line. By providing the water-repellent layer, it is possible to prevent stagnation of water droplets adhering to the surface of the present in-vehicle lens, and further suppress deterioration in image quality of a captured image due to water droplets on the lens surface.

A fluorine compound or a fluorine-based resin is usually used for the water-repellent layer. Examples of the fluorine compound include perfluorooctane carboxylic acid and perfluorooctanoic acid. Examples of the fluorine-based resin include polytetrafluoroethylene (tetrafluoroethylene resin), perfluoroalkoxyalkane (tetrafluoroethylene-perfluoroalkyl vinyl ether copolymer resin), perfluoroethylene propene copolymer (tetrafluoroethylene-hexafluoropropylene copolymer resin), ethylene-tetrafluoroethylene copolymer (tetrafluoroethylene-ethylene copolymer resin), polyvinylidene fluoride (vinylidene fluoride resin), polychlorotrifluoroethylene (trifluorochloroethylene resin), ethylene-chlorotrifluoroethylene copolymer (trifluorochloroethylene-ethylene copolymer resin), tetrafluoroethylene-perfluorodioxole copolymer (tetrafluoroethylene-perfluorodioxole copolymer resin), and polyvinyl fluoride. As the material of the water-repellent layer, commercially available Daikin OPTOOL UD120 (Daikin OPTOOL is a registered trademark) is suitably used.

The water-repellent layer can be created by applying a coating liquid in which the fluorine compound or fluorine-based resin is dissolved or dispersed in water or an organic solvent, and drying it. The application method is the same as that for creating the present hard coat layer, and the organic solvent used for the coating liquid is also the same as above.

In a case where the present in-vehicle lens has the water-repellent layer, the thickness of the water-repellent layer is preferably 20 nm or more and 100 nm or less.

In a case where the present in-vehicle lens has the water-repellent layer, the water-repellent layer is preferably provided on the present antireflection layer. When providing the water-repellent layer on the present antireflection layer, the water-repellent layer may be directly provided on the present antireflection layer, or a primer layer or the like may be provided on the present antireflection layer, and the water-repellent layer may be provided thereon, for the purpose of improving adhesion between the water-repellent layer and the present antireflection layer.

In a case where the present in-vehicle lens has the water-repellent layer, it is preferable that the water-repellent layer 9 is directly provided on the present antireflection layer 3 as shown in FIG. 4, for example, to cover the present antireflection layer 3 in the effective diameter region. Note that the inside of the effective diameter region is a range from the lens effective diameter to the optical axis in the present base member. In FIG. 4, the water-repellent layer 9 covers the entire surface of the present antireflection layer 3 in the effective diameter region, but it does not necessarily have to cover the entire surface, and only needs to cover at least a part of the present antireflection layer 3 in the effective diameter region.

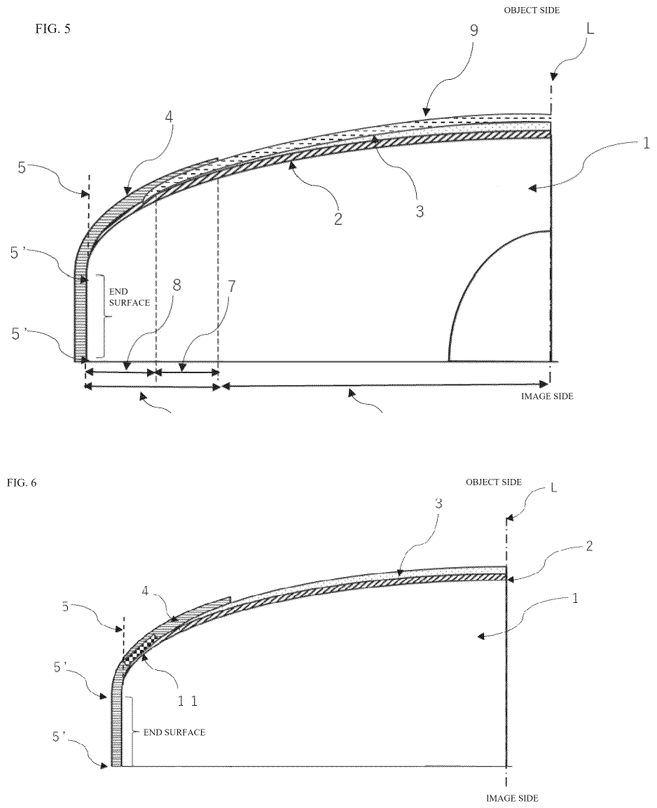

The water-repellent layer 9 does not need to cover the end of the present antireflection layer 3, and may cover up to the end of the present functional film provided on the present antireflection layer as shown in FIG. 4, or the water-repellent layer 9 may be covered with the present functional film 4 as shown in FIG. 5, such that the water-repellent layer 9 is provided between the present antireflection layer 3 and the present functional film 4. When the water-repellent layer 9 is provided between the present antireflection layer 3 and the present functional film 4, the end of the water-repellent layer 9 is preferably in the extra-effective-diameter region as shown in FIG. 5, and more preferably in the second region.

The present functional film preferably has an elastic function in addition to the function of absorbing ultraviolet rays. That is, the present functional film is more preferably an elastic body containing a resin material such as a fluorine-based resin, an acrylic-based resin, and/or a urethane-based resin, as described above. By the present functional film having the elastic function, when the present in-vehicle lens described later is made into a lens unit and housed in a lens barrel, it can also play a role of protecting a part to be caulked facing a caulking portion for fixing the present in-vehicle lens. For the above reason, the functional film preferably has an elastic function so as to be able to absorb stress by the caulking portion.

In another aspect, a protective film that is an elastic body may be added under the present functional film. That is, in another aspect, it may be divided into two films: a film that absorbs ultraviolet rays and an elastic film that absorbs stress by the caulking portion. In this case, the protective film is preferably provided under the present functional film, that is, between the present functional film and the present base member, and at a position corresponding to the part to be caulked facing the caulking portion. For example, as shown in FIG. 6, the protective film 11 may be provided so as to cover only the position corresponding to the part to be caulked.

Materials for the protective film include, for example, fluoropolymer-based resins, urethane-based resins, and acrylic-based resins, which impart elasticity.

The method for creating the protective film is the same as the method for forming the functional film, and after forming the protective film, the functional film is formed by the same technique. When the present in-vehicle lens has the protective film, the protective film can be formed at a desired position by creating it on the present base member, for example, on the end surface of the present base member by the above method, and then creating the present functional film by the above method.

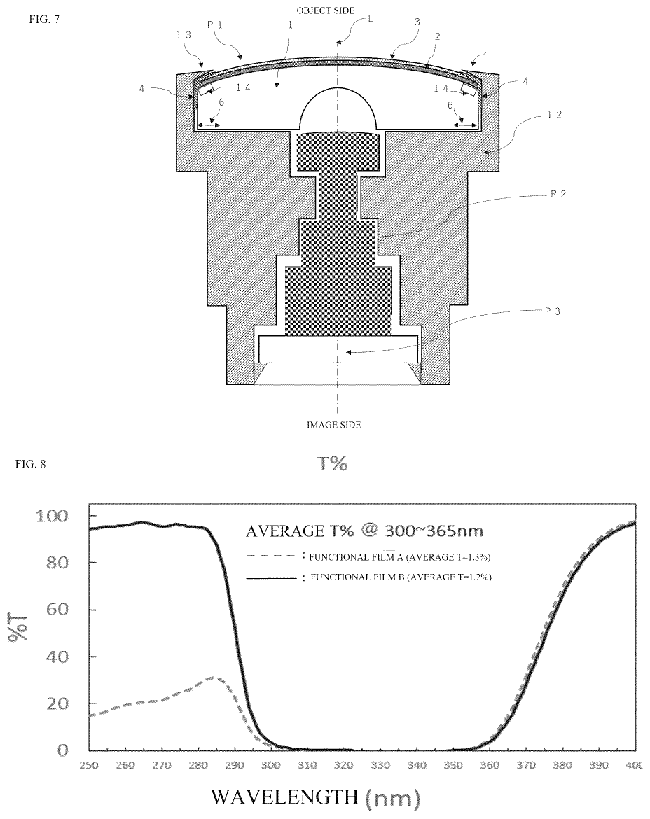

As described above, since the present in-vehicle lens can suppress deterioration of the antireflection function even after long-term use, the present in-vehicle lens can be suitably used as a lens unit (hereinafter also referred to as “the present lens unit”) combined with at least one other lens. When the present in-vehicle lens is used as the present lens unit, as shown in FIG. 7, an aspect can be exemplified in which the present in-vehicle lens P1, in which the surface of the present base member 1 provided with the present hard coat layer 2 and the present antireflection layer 3 is the object side, is used as an outermost lens, and combined with at least one lens P3 on the image side. In FIG. 7, a lens group P2 combining a plurality of lenses may be provided between the present in-vehicle lens P1, which is the outermost lens, and the lens P3. Each lens constituting the lens group P2 combining a plurality of lenses can be used by combining lenses of various shapes depending on the purpose of a camera module having the present lens unit described later. The present in-vehicle lens P1, each lens constituting the lens group P2 combining a plurality of lenses, and each optical axis L of the lens P3 are combined so as to coincide.

When the present in-vehicle lens is used as the outermost lens, the configurations and positions of the present hard coat layer, the present antireflection layer, the present functional film, and the water-repellent layer provided on the present base member are as described above, and the preferred aspects are also as described above.

The present lens unit in FIG. 7 has a lens barrel 12 that houses the present in-vehicle lens P1 as the outermost lens on the object side, and at least one lens P3 on the image side and a lens group P2 combining a plurality of lenses between the outermost lens and the lens P3.

The lens barrel 12 preferably has a caulking portion 13 for fixing the present in-vehicle lens P1 to the object-side end of the lens barrel 12. The caulking portion may be formed throughout the inner circumferential surface of the lens barrel 12, or may be formed on a part of the inner circumferential surface. It is preferable that an O-ring or the like is provided as a sealing member between the outer circumferential surface of each lens constituting the present in-vehicle lens P1, the lens P3, and the lens group P2 and the inner circumferential surface of the lens barrel 12, so that the space between the outer circumferential surface of each lens and the inner circumferential surface of the lens barrel 12 is sealed.

When the present in-vehicle lens P1 is the outermost lens on the object side, similarly to the above, the region from the lens effective diameter to the edge portion of the outermost lens is defined as an extra-effective-diameter region, and it is preferable that a part to be caulked facing the caulking portion is in the extra-effective-diameter region. As for the part to be caulked, it is preferable that the part to be caulked 14 is in the extra-effective-diameter region 6 as shown in FIG. 7. Note that when a protective film is provided separately from the functional film, it is preferable that the part to be caulked is covered with the protective film (not shown), and the present functional film 4 is provided on the protective film as shown in FIG. 7.

Since the present lens unit suppresses deterioration of the antireflection function over long-term use, a camera module having the present lens unit (hereinafter also referred to as “the present camera module”) is suitably used as an in-vehicle camera module. The present camera module usually has the present lens unit, an image sensor, a substrate, and an image signal processor.

The present camera module suppresses deterioration of the antireflection function over long-term use in a harsh environment with a large temperature difference. Therefore, the present camera module can be suitably used as an in-vehicle camera such as an image recognition camera and a recording camera used for a long period of time in a harsh environment as described above.

A method for manufacturing an in-vehicle lens of the present invention (hereinafter also referred to as “the present manufacturing method”) includes: a first step of forming a hard coat layer on a transparent base member mainly composed of a resin; a second step of forming an antireflection layer on the hard coat layer formed in the first step; and a third step of forming a film such that the antireflection layer is covered by a functional film that absorbs ultraviolet rays in an extra-effective-diameter region, where a region from a lens effective diameter to an edge portion in the base member is defined as the extra-effective-diameter region. In the present manufacturing method, the hard coat layer, the antireflection layer, and the functional film are the same as the contents and preferred examples exemplified for the present hard coat layer, the present antireflection layer, and the present functional film, and the first step, the second step, and the third step are the same as the methods for creating the hard coat layer, the antireflection layer, and the functional film described above, and preferred aspects are also the same.

The present in-vehicle lens, the present lens unit, and the present camera module have been described above, but the present invention is not limited to the configurations of the above embodiments. Further, the present manufacturing method has also been described, but the present invention is not limited to the configurations of the above embodiments. Any other configuration may be added to the present in-vehicle lens, the present lens unit, and the present camera module in the configurations of the above embodiments, or any configuration that exhibits similar functions may be replaced. Any other step may be added to the present manufacturing method in the steps of the above embodiments, or any step that exhibits similar effects may be replaced.

### EXAMPLES

Hereinafter, the present invention will be described in detail with reference to Examples, but the present invention is not limited thereto. In the Examples, the following were used for the base member, the hard coat layer, the antireflection layer, the functional film, and the water-repellent layer.

### <Base Member A>

Low birefringence transparent resin AZP (registered trademark) (manufactured by Asahi Kasei Corp.) was used.

### <Hard Coat Layer A>

A hard coat layer was formed by UV curing after spin coating using Nidek Acier J50PG (manufactured by Nidek Co., Ltd., Nidek Acier is a registered trademark) which is a mixture of urethane and amorphous silica and has a solid content concentration of 56.2%. The content of metal oxide fine particles in the hard coat layer after curing was 27%.

### <Antireflection Layer A>

Silicon dioxide as a low refractive index layer and trisilicon tetranitride as a high refractive index layer were alternately laminated in 8 layers such that the outermost layer (the side opposite to the base member) was the low refractive index layer. Lamination was performed by Radical Assisted Sputtering (RAS) using a Shincron RAS1100C (manufactured by Shincron Co., Ltd.) as an apparatus.

### <Functional Film>

Functional Film A: A functional film was formed by a spin coating method using F-2001, which is an original liquid of a one-component Jet Protector F-200SI manufactured by Taihei Kasei Co., Ltd.

Functional Film B: A functional film was formed by a spin coating method using a two-component F-3000 manufactured by Taihei Kasei Co., Ltd.

As shown in FIG. 8, the average transmittance of ultraviolet rays having a wavelength of 315 nm or more and 365 nm or less was 1.3% in the case of functional film A and 1.2% in the case of functional film B.

### <Water-Repellent Layer A>

Formed by a vapor deposition method using Daikin OPTOOL UD120 (manufactured by Daikin Industries, Ltd., Daikin OPTOOL is a registered trademark).

### [Evaluation of Weather Resistance]

Evaluation of weather resistance was performed as follows. A durability test was performed using a 7.5 kW super xenon weather meter as a high-acceleration weather resistance tester. The irradiance was set to 180 W/m², and irradiation and rainfall were performed for 18 minutes, followed by irradiation for 102 minutes, which was taken as one cycle, and 500 cycles of the durability test were performed. After the durability test, those with no damage to the antireflection film were marked as o, and those with damage to the antireflection film were marked as x.

### Example 1

An in-vehicle lens A was created using the base member A as a base member, and creating a hard coat layer A, an antireflection layer A, a water-repellent layer A, and a functional film A as a functional film on the base member A so as to have the layer configuration of FIG. 5. First, after cleaning the surface of the base member A, the hard coat layer A is placed on a spin coater. In that state, about 70 μL of a coating liquid was dropped on the lens surface, and then the lens was rotated. After moving from the spin coating apparatus to a vacuum dryer, it was dried at a set temperature of 80° C. for 30 minutes, and then ultraviolet irradiation was performed for 30 seconds to perform UV curing. Next, the base member A on which the hard coat layer A was formed was placed in a sputtering apparatus. In the sputtering apparatus, after setting a process of alternately depositing high refractive index layers and low refractive index layers four times, sputtering treatment was started. In the antireflection film thus formed, the outermost layer is a low refractive index layer. After the antireflection layer A was formed, the water-repellent layer A was formed by the same sputtering apparatus. Next, the functional film was applied with a brush using the liquid described in the functional film A while the base member A on which each layer and the functional film were created as described above was rotated by the spin coating apparatus. Thereafter, it was placed in a preheated oven and dried by heating at a set temperature of 80° C. for 60 minutes. As a result of formation by the above process, the thicknesses of the hard coat layer, the antireflection layer, the water-repellent layer, and the functional film were 8+0.5 μm, 424 nm, 4000 nm to 20000 nm, and 20 nm to 100 nm, respectively. The weather resistance of the in-vehicle lens A was evaluated by the above method, and the result was o.

### Example 2

An in-vehicle lens P1 was created by forming a hard coat layer A, an antireflection layer A, a water-repellent layer A, and a functional film B as a functional film on a base member 1 so as to have the layer configuration of FIG. 5. The hard coat layer A, the antireflection layer A, and the water-repellent layer A were created by the same procedure as in Example 1. In Example 2, the functional film was created under the same conditions as in Example 1 except that the liquid described in Functional Film B was used. The thicknesses of the hard coat layer, the antireflection layer, the functional film, and the water-repellent layer were 8+0.5 μm, 424 nm, 4000 nm to 20000 nm, and 20 nm to 100 nm, respectively. The weather resistance of the in-vehicle lens B was evaluated, and the result was o.

### Comparative Example 1

An in-vehicle lens C was created in the same manner as in Example 1 except that no functional film was used. The weather resistance of the in-vehicle lens C was evaluated, and the result was x.

### Example 3

The transmittance of ultraviolet rays in the antireflection layer in the effective diameter region was set to 70.0% by adjusting the transmittance of ultraviolet rays in the antireflection layer by applying a material obtained by adding an acrylic resin to the functional film material of

Example 1 to the surface of the antireflection layer. The weather resistance of the in-vehicle lens D on which the antireflection layer with the transmittance thus adjusted was formed was evaluated, and the result was ∘.

TABLE 1

| | | | Comparative | |
|---|---|---|---|---|
| | Example 1 | Example 2 | example 1 | Example 3 |
| Average | 1.3% | 1.2% | 100.0% | 70.0% |
| transmittance | | | | |
| of 315-365 nm | | | | |
| Evaluation of | ○ | ○ | x | ○ |
| weather | | | | |
| resistance | | | | |

As is clear from the above results, by providing the functional film, there was no damage to the antireflection layer even after the evaluation of weather resistance after high acceleration. Therefore, it is considered that deterioration of the antireflection function is suppressed even in long-term use of the present in-vehicle lens. Further, in both Example 1 and Example 2, since the average transmittance of the antireflection layer is set to 70% or less, deterioration of the hard coat layer not covered by the antireflection layer due to ultraviolet rays can be appropriately prevented. When the functional film also has a water-repellent function, it is considered that the present in-vehicle lens can appropriately repel water droplets at the outer peripheral portion. This is considered to be able to further suppress the influence on a captured image due to water droplets. Particularly, in Example 1 in which the water-repellent layer is formed on the antireflection layer, since water droplets are repelled on the entire surface of the in-vehicle lens, the difference in water-repellent performance between the vicinity of the optical axis and the edge portion of the lens can be reduced. Note that in other examples, when there is an inflection point on the surface of the in-vehicle lens, a region from the edge portion of the lens to the inflection point of the lens surface and the end surface of the present base member may also be referred to as “the periphery of the edge of the base member” as the periphery of the edge of the base member. In this case, the functional film has a configuration covering the inflection point as well.

As described above, the following matters are disclosed in this specification.
[1] An in-vehicle lens having a transparent base member mainly composed of a resin, wherein a hard coat layer and an antireflection layer are provided on at least one surface of the base member, the antireflection layer is provided on a side opposite to the base member with respect to the hard coat layer, a region from a lens effective diameter to an edge portion in the base member is defined as an extra-effective-diameter region, and in the extra-effective-diameter region, the antireflection layer is covered by a functional film that absorbs ultraviolet rays.

With the above configuration, deterioration of the antireflection function is suppressed even in long-term use of the in-vehicle lens.
[2] The in-vehicle lens according to [1], wherein the functional film has an ultraviolet transmittance equal to or lower than a transmittance of the antireflection layer.
[3] The in-vehicle lens according to [2], wherein the antireflection layer has an ultraviolet transmittance of 70% or less.
[4] The in-vehicle lens according to any one of [1] to [3], wherein the functional film includes a first range on an optical axis side and a second range on an edge portion side in a radial direction of the extra-effective-diameter region, and the functional film is in contact with the antireflection layer in the first range and is in contact with the hard coat layer in the second range in the extra-effective-diameter region.
[5] The in-vehicle lens according to any one of [1] to [4], wherein a region from a lens effective diameter to an optical axis of the base member is defined as an inside of an effective diameter region, and a water-repellent layer is provided on the antireflection layer in the inside of the effective diameter region.
[6] The in-vehicle lens according to any one of [1] to [5], wherein the water-repellent layer is provided between the antireflection layer and the functional film in the extra-effective-diameter region.
[7] The in-vehicle lens according to any one of [1] to [6], wherein the functional film further has a water-repellent function.

Furthermore, the present invention has the following aspects.
[8] A lens unit having the in-vehicle lens according to any one of [1] to [7] as an outermost lens, and having at least one lens other than the outermost lens.
[9] The lens unit according to [8], having a lens barrel that houses the outermost lens and the at least one lens, wherein the lens barrel has a caulking portion for fixing the outermost lens.

The lens unit according to [9], wherein a region from a lens effective diameter to an edge portion of the outermost lens is defined as an extra-effective-diameter region, a part to be caulked facing the caulking portion is provided in the extra-effective-diameter region of the outermost lens, the functional film is an elastic body containing an organic material, and the part to be caulked is covered by the functional film that is the elastic body.
[11] A camera module having the lens unit according to any one of [8] to [10].

Furthermore, the present invention has the following aspects.
[12] A method for manufacturing a lens, comprising: a first step of forming a hard coat layer on a transparent base member mainly composed of a resin; a second step of forming an antireflection layer on the hard coat layer formed in the first step; and a third step of forming a film such that the antireflection layer is covered by a functional film that absorbs ultraviolet rays in an extra-effective-diameter region, where a region from a lens effective diameter to an edge portion in the base member is defined as the extra-effective-diameter region.

1. An in-vehicle lens comprising a transparent base member mainly composed of a resin,
wherein a hard coat layer and an antireflection layer are provided on at least one surface of the base member,
the antireflection layer is provided on a side opposite to the base member with respect to the hard coat layer,
a region from a lens effective diameter to an edge portion in the base member is defined as an extra-effective-diameter region, and
in the extra-effective-diameter region, the antireflection layer is covered by a functional film that absorbs ultraviolet rays.

2. The in-vehicle lens according to claim 1, wherein the functional film has an ultraviolet transmittance equal to or lower than a transmittance of the antireflection layer.

3. The in-vehicle lens according to claim 2, wherein the antireflection layer has an ultraviolet transmittance of 70% or less.

4. The in-vehicle lens according to claim 1,
wherein the functional film includes a first range on an optical axis side and a second range on an edge portion side in a radial direction of the extra-effective-diameter region, and
the functional film is in contact with the antireflection layer in the first range and is in contact with the hard coat layer in the second range in the extra-effective-diameter region.

5. The in-vehicle lens according to claim 1, wherein a region from a lens effective diameter of the base member to an optical axis of the base member is defined as an inside of an effective diameter region, and a water-repellent layer is provided on the antireflection layer in the inside of the effective diameter region.

6. The in-vehicle lens according to claim 5, wherein the water-repellent layer is provided between the antireflection layer and the functional film in the extra-effective-diameter region.

7. The in-vehicle lens according to claim 1, wherein the functional film further has a water-repellent function.

8. A lens unit having the in-vehicle lens according to claim 1 as an outermost lens, and having at least one lens other than the outermost lens.

9. The lens unit according to claim 8, having a lens barrel that houses the outermost lens and the at least one lens, wherein the lens barrel has a caulking portion for fixing the outermost lens.

10. The lens unit according to claim 9,
wherein a region from a lens effective diameter to an edge portion of the outermost lens is defined as an extra-effective-diameter region,
a part to be caulked facing the caulking portion is provided in the extra-effective-diameter region of the outermost lens,
the functional film is an elastic body containing an organic material, and
the part to be caulked is covered by the functional film that is the elastic body.

11. A camera module comprising the lens unit according to claim 8.

12. A method for manufacturing a lens, comprising:
a first step of forming a hard coat layer on a transparent base member mainly composed of a resin;
a second step of forming an antireflection layer on the hard coat layer formed in the first step; and
a third step of forming a film such that the antireflection layer is covered by a functional film that absorbs ultraviolet rays in an extra-effective-diameter region, the extra-effective-diameter region being defined as a region from a lens effective diameter to an edge portion in the base member.
